(19) United States
(12) Patent Application Publication
(10) Pub. No.: US 2016/0294871 A1
(43) Pub. Date: Oct. 6, 2016

(54) SYSTEM AND METHOD FOR MITIGATING AGAINST DENIAL OF SERVICE ATTACKS

(71) Applicant: Arbor Networks, Inc., Burlington, MA (US)

(72) Inventors: Lawrence B. Huston, III, Ann Arbor, MI (US); Andrew Mortensen, Ann Arbor, MI (US)

(73) Assignee: Arbor Networks, Inc., Burlington, MA (US)

(21) Appl. No.: 14/674,946

(22) Filed: Mar. 31, 2015

(51) Int. Cl. H04L 29/06

(52) U.S. Cl. CPC H04L 63/20; H04L 63/1408; H04L 63/1458; H04L 63/0254

(57) ABSTRACT

A computer-implemented system and method for mitigating against denial of service attacks. The system includes a network having a plurality of programmable network switches and a mitigation device connected to one or more of the network switches. The mitigation device includes logic integrated with and/or executable by a processor. The logic being adapted to monitor network traffic from one or more of the network switches and determine network policies to provide protection against denial of service attacks. The mitigation device is configured and adapted to send a software-defined networking (SDN) protocol signal to the one or more of the network switches to program the one or more of the switches to match and drop attacker data traffic contingent upon the determined network policies.

### FIELD OF THE INVENTION

The disclosed embodiments relate generally to computer networks, and specifically to methods and systems for protecting against denial of service attacks in computer networks by adjusting traffic attack countermeasure policies in programmable network elements.

### BACKGROUND OF THE INVENTION

The Internet is a global public network of interconnected computer networks that utilize a standard set of communication and configuration protocols. It consists of many private, public, business, school, and government networks. Within each of the different networks are numerous host devices such as workstations, servers, cellular phones, portable computer devices, to name a few examples. These host devices are able to connect to devices within their own network or to other devices within different networks through communication devices such as hubs, switches, routers, and firewalls, to list a few examples.

The growing problems associated with security exploits within the architecture of the Internet are of significant concern to network providers. Networks, and network devices are increasingly affected by the damages caused by Denial of Service (“DoS”) attacks. A DoS attack is defined as an action taken upon on a computer network or system by an offensive external device that prevents any part of the network from functioning in accordance with its intended purpose. This attack may cause a loss of service to the users of the network and its network devices. For example, the loss of network services may be achieved by flooding the system to prevent the normal servicing for performing legitimate requests. The flooding may consume all of the available bandwidth of the targeted network or it may exhaust the computational resources of the targeted system.

A Distributed Denial of Service (“DDoS”) attack is a more aggressive action that involves multiple offensive devices performing an attack on a single target computer network or system. This attack may be performed in a coordinated manner by these multiple external devices to attack a specific resource of a service provider network. The targeted resource can be any networking device such as routers, Internet servers, electronic mail servers, Domain Name System (“DNS”) servers, etc. Examples of a DDoS attack include (but are not limited to): large quantities of raw traffic designed to overwhelm a resource or infrastructure; application specific traffic designed to overwhelm a particular service; traffic formatted to disrupt a host from normal processing; traffic reflected and/or amplified through legitimate hosts; traffic originating from compromised sources or from spoofed IP addresses; and pulsed attacks (which start/stop attacks). Further, it is to be understood DDoS attacks are typically categorized as: TCP Stack Flood Attacks (e.g., flood a certain aspect of a TCP connection process to keep the host from being able to respond to legitimate connections (which may also be spoofed)); Generic Flood Attacks (e.g., consists of a flood of traffic for one or more protocols or ports, which may be designed to appear like normal traffic which may also be spoofed)); Fragmentation Attacks (e.g., consists of a flood of TCP or UDP fragments sent to a victim to overwhelm the victim's ability to re-assemble data streams, thus severely reducing performance); Application Attacks (e.g., attacks designed to overwhelm components of specific applications); Connection Attacks (e.g., attacks that maintain a large number of either ½ open TCP connections or fully open idle connections); and Vulnerability Exploit Attacks (e.g., attacks designed to exploit a vulnerability in a victim's operating system).

The architecture of the Internet makes networks and network devices vulnerable to the growing problems of DDoS attacks. Therefore, the ability to avoid or mitigate the damages of a DDoS attack, while preventing blocking of valid hosts, is advantageous to devices located in a protected network.

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, a computer-implemented system and method for mitigating against denial of service attacks is described. The system includes a network having a plurality of programmable network switches and a mitigation device connected to one or more of the network switches. The mitigation device includes logic integrated with and/or executable by a processor. The logic being adapted to monitor network traffic from one or more of the network switches and determine network policies to provide protection against denial of service attacks. The mitigation device is configured and adapted to send a software-defined networking (SDN) protocol signal to one or more of the network switches to program one or more of the switches to match and drop attacker data traffic contingent upon the determined network policies.

In accordance with certain illustrated embodiments of the present invention, what is described is intelligent use of programmable networks to scale protection particularly against large denial of service attacks (e.g., DDoS). It is to be appreciated that by combining local network traffic analysis with the capabilities of programmable network elements, a mitigation device can continuously update network policies to scale protection against attacks many times larger than the mitigation device's processing capacity. It is to be further appreciated that the scalable protection reduces attack impact not only on the attack targets, but also on the network bearing the attack load.

### BRIEF DESCRIPTION OF THE DRAWINGS

The accompanying appendices and/or drawings illustrate various non-limiting, example, inventive aspects in accordance with the present disclosure:

FIGS. 1A and 1B illustrate diagrams of a SDN utilized to describe the various disclosed embodiments;

FIG. 2 is a flowchart illustrating a method in accordance with the illustrated embodiments; and

FIG. 3 is a block diagram of a mitigation device of FIG. 1.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

It is to be understood a software defined networking (SDN) is a type of networking architecture that provides centralized management of network elements (e.g., 102-1 to 102-N) rather than a distributed architecture utilized by conventional networks. That is, in a distributed architecture each network element makes a routing, switching, and similar decisions based on the results of traffic processing and a distributed control mechanism. In contrast, in the SDN, a network element follows routing, or switching, decisions received from a central controller.

Briefly, the operation of a network element can be logically divided into a “control path” and a “data path”. In the control path, control protocols, e.g., for building in routing protocols, a spanning tree, and so on, are operable. In the data path, packets-processing operations are performed on a per-packet basis. Such operations include examining each incoming packet and making decisions based on the examination as to how to handle the input packet (e.g., packet forwarding, packet switching, bridging, load balancing, and so on). Furthermore, in a conventional network, network elements typically include both the control and data planes, whereas in a native SDN, the network elements include the data path, and the central controller implements the control path. It is to be appreciated that the network elements may support hybrid SDN/conventional networking, in which the SDN programmability layer is available on top of configured conventional networking. Such network elements may also be programmed for DDoS protection.

It is to be appreciated the SDN can be implemented in wide area networks (WANs), local area networks (LANs), the Internet, metropolitan area networks (MANs), ISP backbones, datacenters, inter-datacenter networks, and the like. Each network element in the SDN may be a router, a switch, a bridge, a load balancer, and so on, as well as any virtual instantiations thereof.

For instance, in one illustrated configuration of a SDN, the central controller communicates with the network elements using the OpenFlow protocol. Specifically, the OpenFlow protocol allows adding programmability to network elements for the purpose of packets-processing operations under the control of the central controller, thereby allowing the central controller to dynamically define the traffic handling decisions in the network element. To this end, traffic received by a network element that supports the OpenFlow protocol is processed and forwarded according to a set of rules defined by the central controller.

Traffic received by a network element that supports the OpenFlow protocol is processed and routed according to a set of rules defined by the central controller based on the characteristic of the required network operation. Such a network element routes traffic according to, for example, a flow table and occasionally sends packets to the central controller. Each network element is preferably programmed with a flow table and can be modified by the central controller as required.

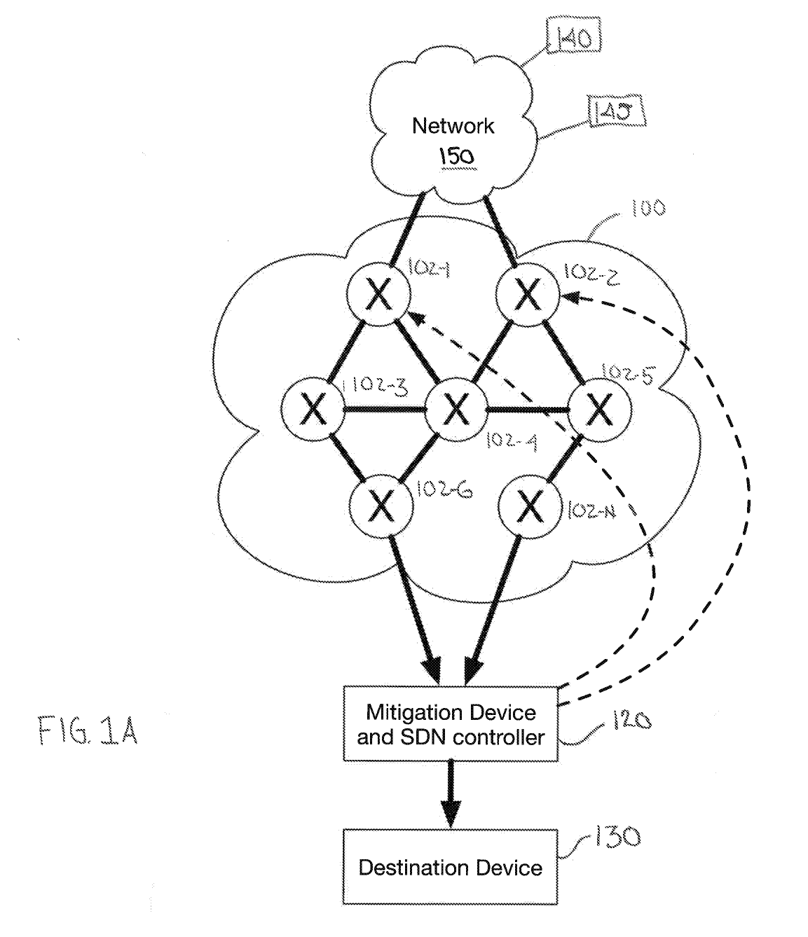

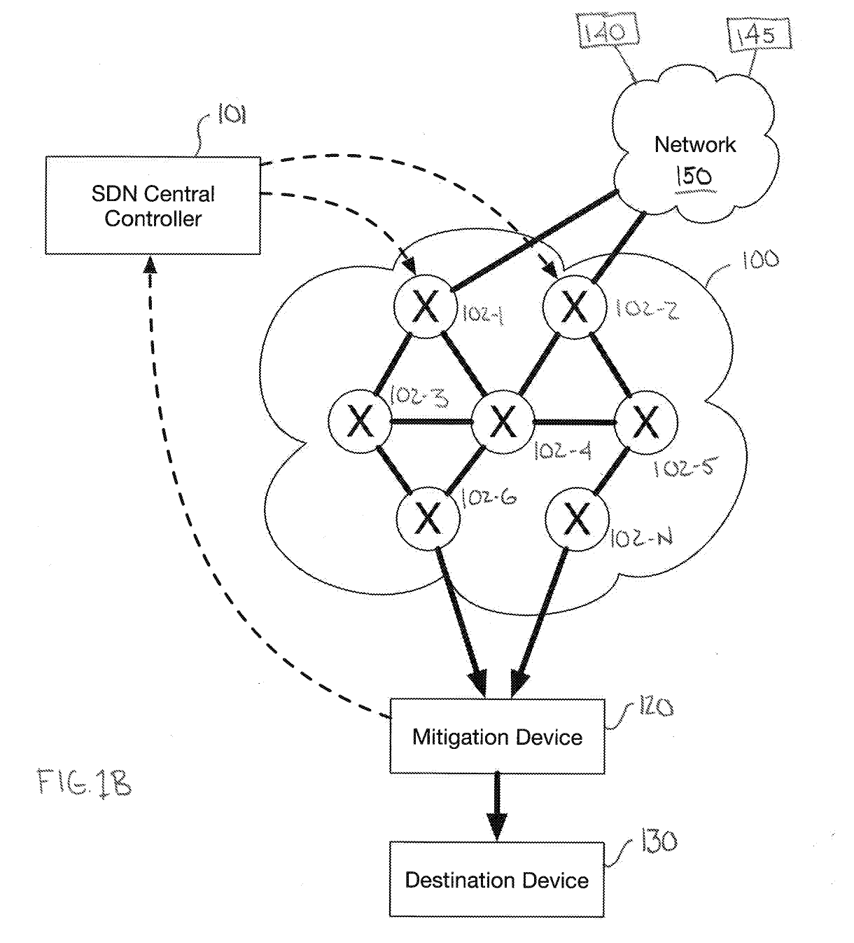

With the basics of an SDN architecture being described above, and in accordance with an illustrated embodiment of the present invention, reference is now made to FIG. 1A which is an exemplary and non-limiting diagram illustrating a topology of a SDN-based network (hereinafter SDN) 100 utilized to describe the various embodiments discussed herein. In the illustrated embodiment of FIG. 1, it is to be understood the SDN-100 includes a central controller configured onto a mitigation device 120, as discussed hereinafter. The SDN-100 includes a plurality of network elements 102-1 through 102-N. Each network element 102 may be a networking switching element having logic integrated with and/or executable by a processor.

To the SDN 100 are further connected a mitigation computing device 120, at least one destination device 130 (e.g., server), and a plurality of client devices 140, 145 that may communicate with the destination server 130 through a network 150 and the SDN-based network (hereinafter SDN) 100. It is to be understood and appreciated the destination device 130 may be operable in a cloud-system infrastructure, a hosting server, service provider networks or a cooperate network.

It is to be understood and appreciated the network 150 which is external to the SDN 100 may be, for example, a WAN, the Internet, an Internet service provider (ISP) backbone, and the like. The SDN 100 can be implemented as wide area networks (WANs), local area networks (LANs), service provider backbones, datacenters, inter-datacenter networks, a private cloud, a public cloud, a hybrid cloud, and the like. It should be noted that although a pair of clients and one destination server are depicted in FIG. 1 merely for the sake of simplicity, the embodiments disclosed herein can be applied to a plurality of clients, servers, and datacenters.

In accordance with an illustrated embodiment of the present invention, the mitigation device 120 is configured to process traffic received from the network elements 102 for the purpose of mitigating denial-of-service (DoS) or distributed DoS (DDoS) attacks against the destination server 130. As discussed further below, the mitigation device 120 is configured to analyze data traffic from the network elements 102 to update network policies to scale protection against attacks so as to reduce attack impact not only on the attack targets (e.g., destination device 130) but also on the network 100 bearing the attack load. The mitigation device 120 is configured and operable to track sources of traffic (via network elements 102) violating locally-defined network policies, and utilizes SDN network protocols (e.g., OpenFlow, FlowSpec or other suitable available software defined networking protocols) to push policies blocking attack sources (e.g., device 140) to the “upstream” programmable network elements 102. It is to be understood and appreciated the mitigation device 120 is preferably configured and operable to: 1) continuously analyze and scrub network traffic; 2) adjust attack policies for network elements 102 in response to changes in characteristics and sources of ongoing attacks to match and drop attack traffic; and 3) decide whether updated attack policies are required (preferably via feedback from the network elements 102).

In a preferred embodiment, the mitigation device 120 is further configured to detect DoS/DDoS attacks by determining if incoming traffic from SDN 100 is suspected of including threats by monitoring traffic addressed to the destination device 130. The mitigation device 120 can be configured to detect DoS/DDoS attacks based on (but not limited to) network and bandwidth statistics, such as an average number of active connections, an average number of packets received per second, and other DoS/DDoS detection attacks known in the related art.

According to certain other configurations, such as the one illustrated in FIG. 1B, mitigation device 120 may be communicatively coupled to a SDN central controller 101 (e.g., an OpenDaylight controller, Floodlight controller or any other suitable SDN controller). In one illustrated embodiment, the mitigation device 120 communicates with the central controller 101 via their Application Program Interfaces (APIs) to provide the updated attack policies for network elements 102. Thus, based, in part, on the information received from the mitigation device 120, the controller 101 is configured to program the network elements 102 with attack decisions that they should take (e.g., drop certain traffic). Thus, the controller 101 relays the mitigation device's messages (e.g., traffic policies) to the SDN-100 using the native SDN protocols of the SDN central controller 101.

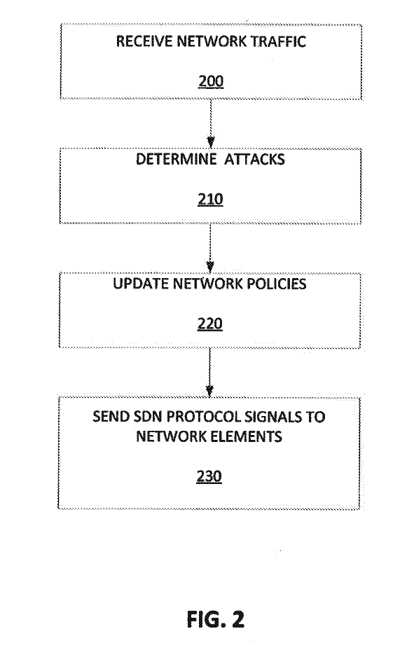

FIG. 2 shows an exemplary and non-limiting flowchart 200 illustrating a method for updating network traffic policies responsive to network attacks in accordance with certain illustrated embodiments. Starting at step 200, traffic from SDN network 100 (routed to a destination device 130), and via programmable network elements 102, is received in the mitigation device 120. As discussed herein, it is to be appreciated mitigation device 120 is configured and operable to continuously analyze the received network traffic so as to continuously update network traffic policies for the network elements 102. The mitigation device 120 is then further configured and operable to determine if a potential attack has been detected (step 210). For instance, and as mentioned above, a potential attack may comprise (but is not to be understood to be limited to) tracking sources of traffic violating locally-defined network policies, including detecting DoS/DDoS attacks based on network and bandwidth statistics, such as an average number of active connections, an average number of packets received per second, and other DoS/DDoS detection attacks known in the related art.

Next at step 230, the mitigation device 120 determines and/or updates network traffic policies preferably contingent upon the attack determination of step 220. For instance, such a network policy may include instructions for a network element 102 to drop traffic having certain attack characteristics, as mentioned above. It is to be appreciated the logic in the mitigation device 120 is adapted to adjust the network policies in response to changes in the characteristics and sources of ongoing data attacks against the network 100. In accordance with certain illustrated embodiments, the logic in the mitigation device 120 is further adapted to analyze feedback from one or more of the network elements 102 to update the determined network polices (e.g., wherein updating the determined network polices is responsive to changes in at least one of attack sources and attack characteristics).

Proceeding to step 230, the mitigation device 120 is then configured to send a SDN protocol signal to the one or more of the network elements 102 in the network 100 to program the one or more of the network elements 102 to match and drop attacker data traffic contingent upon the aforesaid determined network policies. As mentioned above, the SDN protocol signal may consist of OpenFlow, FlowSpec or other suitable available software defined networking protocols.

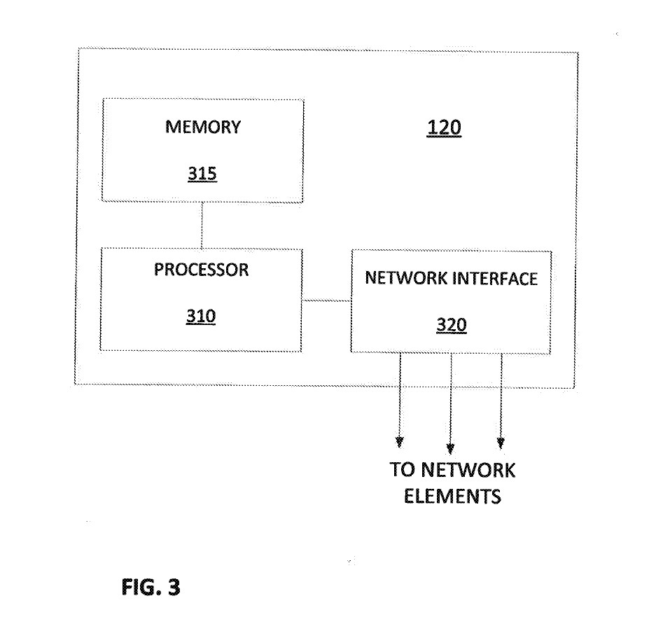

With reference now to FIG. 3, illustrated is an exemplary and non-limiting block diagram of the mitigation device 120 constructed according to an illustrated embodiment. The mitigation device 120 is operable in a SDN 100, such as those defined above, and is at least configured to execute the method for updating attack policies as described in greater detail above. The mitigation device 120 preferably includes a processor 410 coupled to a memory 415 and a network-interface module 420. The network-interface module 420 allows the communication with the network elements of the SDN 100. In one embodiment, such communication uses the OpenFlow protocol discussed above with each network element 102. The processor 410 uses instructions stored in the memory 415 to execute policy updating tasks as well as to control and enable the operation of the network-interface module 420.

The foregoing detailed description has set forth a few of the many forms that the invention can take. It is intended that the foregoing detailed description be understood as an illustration of selected forms that the invention can take and not as a limitation to the definition of the invention.

Most preferably, the various embodiments disclosed herein can be implemented as any combination of hardware, firmware, and software. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

What is claimed is:

1. A system, comprising:
a network, comprising:
a plurality of network switches;
a mitigation device connected to one or more of the plurality of switches in the network, the mitigation device comprising logic integrated with and/or executable by a processor, the logic being adapted to:
monitor network traffic from one or more of the plurality of switches in the network;
determine, via monitoring of the network traffic, network policies to provide protection against data attacks against the network; and
send a software-defined networking (SDN) protocol signal to the one or more of the plurality of switches in the network to program the one or more of the plurality of switches to match and drop attacker data traffic contingent upon the determined network policies.

2. The system as recited in claim 1, wherein the mitigation device continuously analyzes the monitored network traffic so as to continuously update the determined network policies.

3. The system as recited in claim 1, wherein the data attacks against the network are associated with Distributed Denial of Service (DDoS) attacks.

4. The system as recited in claim 1, wherein the one or more of the plurality of switches comprises logic integrated with and/or executable by a processor.

5. The system as recited in claim 1, wherein the SDN protocol signal operates in accordance with OpenFlow.

6. The system as recited in claim 1, wherein the SDN protocol signal operates in accordance with FlowSpec.

7. The system as recited in claim 1, wherein the logic in the mitigation device is further adapted to adjust the network policies in response to changes in the characteristics and sources of ongoing data attacks against the network.

8. The system as recited in claim 1, wherein the logic in the mitigation device is further adapted to analyze feedback from the one or more of the plurality of switches to update the determined network polices.

9. The system as recited in claim 8, wherein updating the determined network polices is responsive to changes in at least one of attack sources and attack characteristics.

10. The system as recited in claim 1, wherein the mitigation device is an SDN controller element.

11. The system as recited in claim 1, wherein the mitigation device is coupled to a SDN controller element.

12. A mitigation device connected to one or more of the plurality of switches in a network, the mitigation device comprising logic integrated with and/or executable by a processor, the logic being adapted to:
execute an application to determine, via monitoring of the network traffic through the one or more of the plurality of network switches, network policies to provide protection against data attacks against the network;
send a software-defined networking (SDN) protocol signal to the one or more of the plurality of switches in the network to program the one or more of the plurality of switches to match and drop attacker data traffic contingent upon the determined network policies.

13. The mitigation device as recited in claim 12, wherein the mitigation device continuously analyzes the monitored network traffic so as to continuously update the determined network policies.

14. The mitigation device as recited in claim 12, wherein the data attacks against the network are associated with DDoS attacks.

15. The mitigation device as recited in claim 12, wherein the one or more of the plurality of switches comprises logic integrated with and/or executable by a processor.

16. The mitigation device as recited in claim 12, wherein the SDN protocol signal operates in accordance with one of OpenFlow and FlowSpec.

17. The mitigation device as recited in claim 12, wherein executing the application further adjusts the network policies in response to changes in the characteristics and sources of ongoing data attacks against the network.

18. The mitigation device as recited in claim 12, wherein executing the application further analyzes feedback from the one or more of the plurality of switches to update the determined network polices.

19. The mitigation device as recited in claim 18, wherein updating the determined network polices is responsive to changes in at least one of attack sources and attack characteristics.

20. The mitigation device as recited in claim 12, wherein the mitigation device is an SDN controller element.
